(19) United States
(12) Patent Application Publication
(10) Pub. No.: US 2002/0126948 A1
(43) Pub. Date: Sep. 12, 2002

(54) Translational optical shutter for a fiber optic switch

(75) Inventors: Martin Lim, San Mateo, CA (US); Yongli Huang, San Jose, CA (US)

Correspondence Address: FLEHR HOHBACH TEST, ALBRITTON & HERBERT LLP, Suite 3400, Four Embarcadero Center, San Francisco, CA, 94111, US

(73) Assignee: SiTek, Inc.

(21) Appl. No.: 09/799,941

(22) Filed: Mar. 6, 2001

(51) Int. Cl. G02B 6/35

(52) U.S. Cl. 385/17; 385/18

(57) ABSTRACT

A translational optical shutter for a fiber optic switch uses movable mirrors at all matrix cross-points formed by micro electromechanical techniques from a single crystal silicon wafer which is of the 110 crystal plane type and which has been preferentially etched in the 111 plane to provide the appropriate mirror switching surface at the same time as the actuator for the mirror.

The present invention is directed to a translational optical shutter for a fiber optic switch and, more particularly, to a method for producing a suitable mirror which reflects or redirects light from one fiber to another.

### BACKGROUND OF THE INVENTION

As disclosed in a co-pending application entitled FIBER OPTIC SWITCH USING MEMS (microelectrical mechanical system), filed Feb. 15, 2000, Ser. No. 09/504,632, with two of the same inventors as in the present application, because of the great demand for data-centric services brought on by the explosive growth of the Internet, there is a need for all optical switching networks. Such network applications require switching matrices from 8×8 to 1024×10²⁴. The above co-pending application provides one technique for providing such a switch. However, there is still a need for an improved and simplified technique using micro electromechanical techniques for even better optical switches.

### OBJECT AND SUMMARY OF THE INVENTION

It is a general object of the present invention to provide an improved fiber optic switch.

In accordance with the above object, there is provided an optical matrix switch having a plurality of cross-points for switching a plurality of information carrying light beams between any one of a plurality of input beams to any one of a plurality of output beams by choosing the appropriate cross-point of the matrix, each cross-point being a micro electromechanical (MEM) type mirror having a first position where the mirror reflects the selected input beam to provide a selected one output beam and a second position where it provides a through path for transmission of the light and the means actuate the selected cross-point mirror to the first position to reflect the input beam to the output beam and to cause the remaining mirrors in the path of such beam to remain in the second position to allow through transmission. The cross-point mirror is an integral part of the actuating means such integral combination being formed on a single crystal silicon wafer of the 110 crystal plane type where the 111 plane of the wafer is preferentially etched to produce the actuating means and an integral surface reflecting serving as the mirror.

In addition, a method for the above is provided.

### BRIEF DESCRIPTION OF THE DRAWINGS

FIG. 1 is a perspective view in simplified form of a fiber optic switch embodying the present invention.

FIG. 2 is a plan view illustrating the construction of FIG. 1.

FIG. 3 is a simplified and enlarged cross-sectional view of a single mirror and its actuating portion.

FIG. 4 is a simplified perspective view of a portion of FIG. 3.

FIG. 5 is a flow chart illustrating the process of the present invention.

### DETAILED DESCRIPTION OF PREFERRED EMBODIMENT

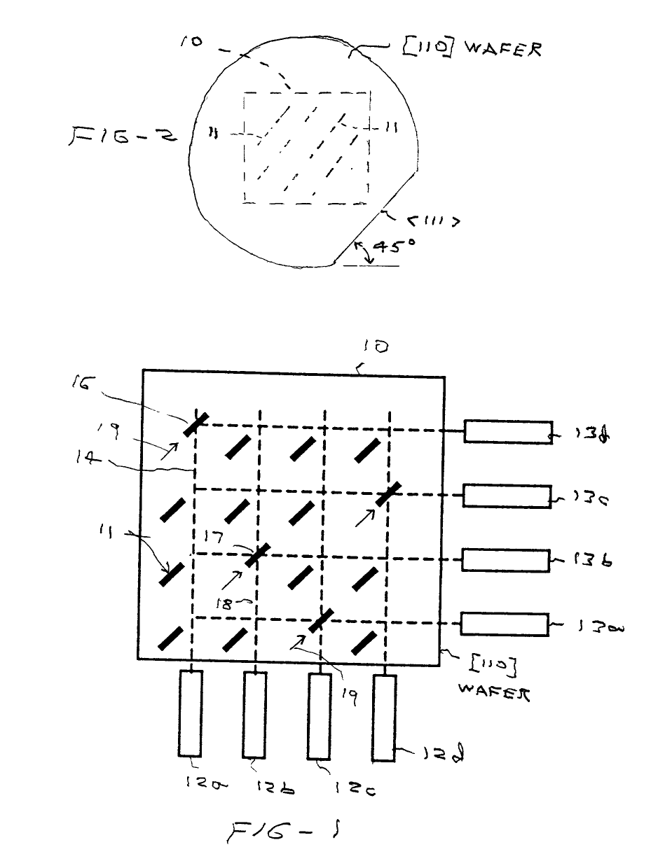

FIG. 1 illustrates a simplified optical matrix switch constructed in accordance with the present invention which is based on micro electromechanical systems (MEMS). The device includes a silicon or other semiconductor substrate or wafer 10 on which is placed a matrix of cross-point mirrors 11. These are located at all possible cross-points or intersections of a plurality of input information carrying light beams 12a-12d (many more are possible, of course) and a plurality of output beams 13a-13d. Typically, these would be of fiber optic lines. From a switching standpoint, this is similar to a mechanical cross-bar switch where it is desired to allow any one selected input 12a-12d to be connected to any one selected output 13a-13d. Thus, the cross-points 11 located at every possible switching junction are in the form of mirrors having a first position where the mirror reflects a selected input beam to provide a selected output beam and a second position where through transmission is allowed. This movement is shown by the arrows 19. The mirrors are etched on a mono-crystalline silicon wafer 10 which has been polished to optical flatness.

Thus, in the case of the input 12a, a beam 14 is reflected by a mirror 16 at a right angle and continues on path to the output 13d. Similarly, the input 12b is reflected at the mirror cross-point 17 and its light path 18 is redirected to the output 13b. The other cross-point mirrors provide that the light beams 14 and 18 have clear transmission through all the intervening cross-points 11.

Thus far, the optical switch described is similar to that of the above co-pending application.

However, in accordance with the present invention, mirrors 11 which can be thought of as extending vertically from a horizontal substrate or wafer 10 are constructed from the substrate by etching at the same time that the actuator means for providing the translational movement from one position to the other is etched; specifically, the first position as shown by mirrors 16 and 17 where the mirror reflects the light beam to a second position where it allows for clear transmission.

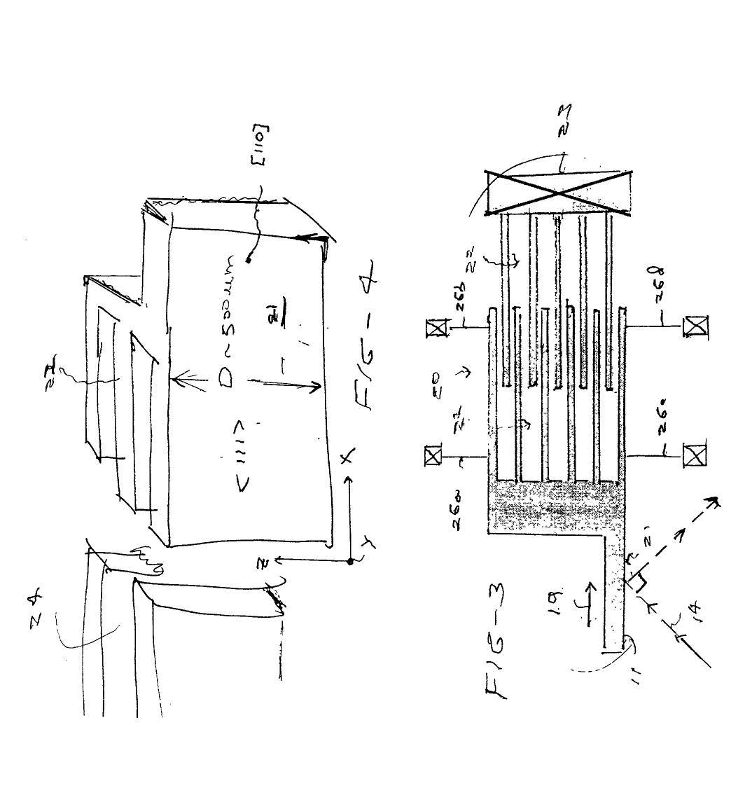

To form the multiple mirrors 11 on the wafer 10, a circular wafer as illustrated in FIG. 2 of the 110 crystal plane type is utilized having the 111 crystal plane; in this case, it is a 45° angle related to the horizontal as illustrated in FIGS. 1 and 2 which is the same alignment as the final mirrors as shown in dashes. This particular 111 plane is preferentially etched which also produces the actuating means for moving the mirrors 11 from their first to their second position. Thus, as the integral mirror and actuator are indicated in FIG. 3 where it is an integral part that is formed from the same silicon wafer 10 as an actuator 12 of the comb type. Here, a typical light path 14 is shown as incident at a 45° angle on the mirror or reflecting surface 21 and being reflected at the indicated 90° angle to another optical fiber. The actuator for the mirror 11 and its surface 21 is the actuator 20 which includes a set of fixed fingers 22 anchored at 23 to the wafer 10 and the movable fingers 24 movable between first and second positions as indicated by the arrow 19 (it is now in a first position where it reflects). Movable fingers 24 are mounted for movement by struts 26a through 26d which are appropriately anchored to the wafer 10.

In addition to the comb filter, a parallel plate configuration as an actuator can also be utilized.

FIG. 4 is a perspective view of the fingers 22 and 24 in simplified form along with the mirrored face 21. This mirrored face is in the 111 crystal plane assuming that the original wafer is a 110 crystal configuration. A representative depth, O, of the mirrored surface 21 to provide for effective switching and reflection might be approximately 500 μm.

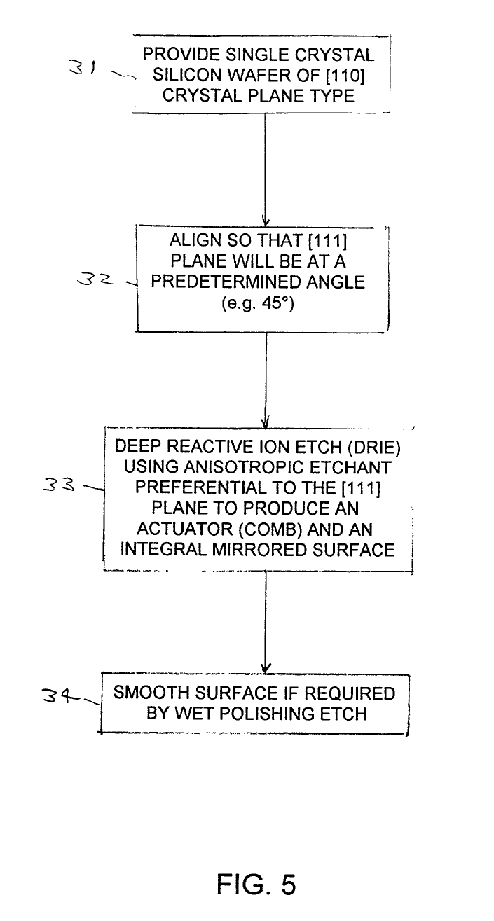

The structure illustrated in FIGS. 3 and 4 where the mirror 11 and its reflecting surface 21 is integrally formed with the actuator means as part of the initial wafer 10 is accomplished by the processing steps indicated in FIG. 5. In step 31, a single crystal silicon wafer 10 is provided of the 110 crystal plane type. In step 32, this wafer is aligned as illustrated and discussed in FIG. 2 so that the 111 plane will be at a predetermined angle. Typically, this angle in most situations would be 45°. In step 33, a deep reactive ion etch (DRIE) using an anisotropic etchant preferential to the 111 plane is used to produce the actuator comb 22, 24 and at the same time integral mirrored surface 21. Such an anisotropic etching preferably uses potassium hydroxide (KOH) an organic aqueous alkaline solution, or ethylenediamine-pyrocatechol-water (organic) (EDP) which are preferential etching solutions which take advantage of the different reactivities of the different crystal planes of a single crystal wafer. In the case of the present invention, it has been discovered that if a 110 type crystal wafer is utilized and aligned properly then a preferential etch can be conducted on the 111 plane to provide a flat surface suitable to reflect light. This vertical plane is ideal for switching in the xy configuration where the plane is moved into and out of the path of the light. The processing is simplified since this reflective plane is formed simultaneously with the actuator structure that provides the translational movement. Further processing details are shown in the above co-pending application.

Referring still to FIG. 5, step 34 provides, if necessary, a smoother reflective surface by wet polishing etch or other techniques. Such techniques may be an additional potassium hydroxide etch. Also, a silicon dioxide layer can be formed on the mirror and then taken off to provide a smoother surface. Since a relatively deep etch is required in a vertical plane which etches more slowly than other orientations, the long etch can possibly compromise even the 111 surface.

Thus, an improved translational optical switch has been provided:

What is claimed is:

1. In an optical matrix switch having a plurality of cross-points for switching a plurality of information carrying light beams between any one of a plurality of input beams to any one of a plurality of output beams by choosing the appropriate cross-point of the matrix,
each cross-point being a micro electromechanical (MEM) type mirror having a first position where said mirror reflects said selected input beam to provide a selected one output beam and a second position where it provides a through path for transmission of said light,
means for actuating a said selected cross-point mirror to said first position to reflect said input beam to said output beam and for causing the remaining mirrors in the path of such beam to remain in the second position to allow through transmission;
said cross-point mirror being an integral part of said actuating means such integral combination being formed on a single crystal silicon wafer of the 110 crystal plane type where the 111 plane of said wafer is preferentially etched to produce said actuating means and an integral reflecting surface serving as said mirror.

2. A matrix switch as in claim 1 where said preferential etching uses potassium hydroxide as an etchant.

3. A method of switching a selected one of a plurality of input optical signal paths to a selected one of a plurality of output optical signal paths comprising the steps of providing a matrix of optical mirrors at all cross-points of said input and output optical paths; selectively and digitally moving one of said mirrors into an optical path to allow a selected input optical path to be reflected to a selected output optical path, and allowing the remaining mirrors in said optical path to provide through transmission,
and forming said cross-point mirrors as an integral part of actuating means for moving said mirrors by providing a single crystalline wafer of the 110 crystal plane type where the 111 plane of said wafer is preferentially etched to produce said actuating means and an integral surface serving as said mirror.

4. A method as in claim 3 including the step of aligning said wafer so that the 111 plane will be at a predetermined angle.

5. A method as in claim 3 including the step of polishing said mirror surface.
